(19) United States
(12) Patent Application Publication
(10) Pub. No.: US 2016/0271827 A1
(43) Pub. Date: Sep. 22, 2016

(54) Harlan hybrid wood/concrete furniture

(71) Applicant: Keith Wyman, Golden Valley, MN (US)

(72) Inventor: Keith Wyman, Golden Valley, MN (US)

(21) Appl. No.: 14/661,068

(22) Filed: Mar. 18, 2015

(51) Int. Cl. B28B 1/16; B28B 7/34

(52) U.S. Cl. CPC B28B 1/16; B28B 7/348

(57) ABSTRACT

A frame member is provided for fixing wood and concrete and a method for adjoining wood and concrete to form hybrid wood/concrete furniture. The frame member includes a series of lag bolts spaced apart wherein a first portion of the lag bolts is screwed into the wood and a second portion of the lag bolts is left exposed from the wood. The second portion of the lag bolts is welded to a steel rebar frame. The frame member is then framed in a melamine, rubber or wood form in order to allow concrete to be poured around the frame member and held in place until cured.

### BACKGROUND OF THE INVENTION

Concrete and wood products have been used as building and construction materials for quite some time. However, in most applications wood is rarely permanently fixed to concrete due to the fact that concrete is not significantly degraded over time due to exposure to water and wood generally decays over time due to exposure to water. As a result, hybrid wood and concrete products are not very common especially in areas where the products may be exposed to moisture due to the fact that wood generally decays over time due to exposure to water.

Composite wood-concrete building members are known to exist in industrial construction applications for fixing wood slabs or beams to concrete slabs. However, these building members are generally used for large scale concrete slabs and construction applications and are not used for the construction of hybrid wood/concrete furniture which requires fixing members that ensure that wood is fixed to concrete with a seamless joint and with minimal cracking in the concrete. In producing hybrid wood/concrete furniture it is very important to adjoin the wood and concrete with a fixture that results in a seamless and smooth transition between the wood and concrete and that also minimizes the amount of cracking in the poured and finished concrete.

Industrial-type indoor furniture has been rapidly rising in popularity in recent years. Many different types of building products such as various types of metal, concrete and wood are used to create unique furniture, design and functional architectural pieces that have an industrial look. However, in joining concrete and wood products to create furniture quality pieces it is difficult to create a seamless joint between the wood and concrete that results in a finished product that has minimal cracking in the concrete. In particular, it is difficult to create a seamless joint between wood and concrete when wood having an unfinished and irregularly shaped or natural edge is used. Most pieces of raw wood have curved and irregularly shaped edges. These irregular edges have a very natural look that is appealing to many when incorporated into decorative furniture. However, the irregular or natural edge makes it particularly difficult to create a seamless joint between the wood and concrete when creating hybrid wood/concrete furniture.

### SUMMARY OF THE INVENTION

In accordance with an aspect of the present invention a frame member for fixing wood and concrete and a method for adjoining wood and concrete to form hybrid wood/concrete furniture is provided. The frame member includes a series of lag bolts spaced apart wherein a first portion of the lag bolts is screwed into the wood and a second portion of the lag bolts is left exposed from the wood. The second portion of the lag bolts is welded to a steel rebar frame. The frame member is then framed in a melamine, rubber or wood form in order to allow concrete to be poured around the frame member and held in place until cured.

In joining wood and concrete it is difficult to create a seamless joint between the wood and concrete that results in a finished product that has an aesthetically pleasing joint between the wood and the concrete and minimal cracking in the concrete. In particular it is difficult to create a seamless joint between wood and concrete when wood having an unfinished and irregularly shaped edge is used. Advantageously, the present invention includes lag bolts that are mounted at irregularly spaced intervals in unfinished and irregularly shaped wood with a natural edge. The lag bolts are mounted closer together in areas where the wood has an irregular shape or slope in natural edge of wood strengthening bond between wood and concrete and making up for larger potential spacing around knots or unstable areas, and the lag bolts are mounted farther apart in areas where the wood has a generally straight edge. In addition, the lag bolts are not mounted in any areas of the wood that may be unstable such as areas that include natural knots which could conceivably lead to movement in the wood over time that would then affect concrete if lag bolt were to be adhered in such as unstable area; tighter placement of lags on either side of natural knot or potential unstable area heighten or strengthen cohesion between wood and concrete. Lag bolts can then be easily adjusted with any wrench or tool for slight adjustment in or out of the wood so that all lag bolt heads line up in straight line for proper tacking to the straight edged rebar frame. Grinding of lag bolt may be necessary for proper tack weld preparation, especially if using a galvanized lag bolt. This will prevent harmful and potentially dangerous hot, molten weld splattering.

Proper preparation of the wood slab ahead of time with the appropriate wood sealer or finisher (e.g. water or oil based polyurethane, Waterlox finish, masonry joint compound, etc.) is also paramount, giving our wood slab the necessary water tight seal or waterproof barrier further stabilizing the wood and disabling the possibility of further movement of said wood during and after concrete curing and to disallow water infiltrating the wood when pouring in fresh, wet concrete mix into the form alongside the wood.

Recommended thickness of wood and concrete product to be one and a half inches thick when using a minimum 8000 psi concrete mix at 28-day full strength cure on final bench or table that is up to 56 inches in length or span. Hybrid wood/concrete bench or table may be as thin as 1.4″ on final thickness of wood and concrete product that is 42 inches or less in length or span. Lengths and thicknesses can vary depending on product load requirements.

### BRIEF DESCRIPTION OF THE DRAWINGS

FIG. 1 shows a method for creating a frame member for joining wood and concrete;

FIG. 2 shows a process of placing lag bolts in a wood portion of a piece of furniture in order to prepare for a concrete pour;

FIG. 3 shows a process of attaching a steel rebar frame to lag bolts placed in a wood portion of a piece of furniture in order to prepare a concrete pour;

FIG. 4 shows a process of framing a wood portion of a piece of furniture, lag bolts and a rebar frame in a melamine, rubber or wood form in order to prepare the wood, lag bolts and rebar frame for a concrete pour; and

FIG. 5 shows a finished hybrid wood/concrete furniture product having a seamless joint and minimal cracking in the concrete

### DETAILED DESCRIPTION

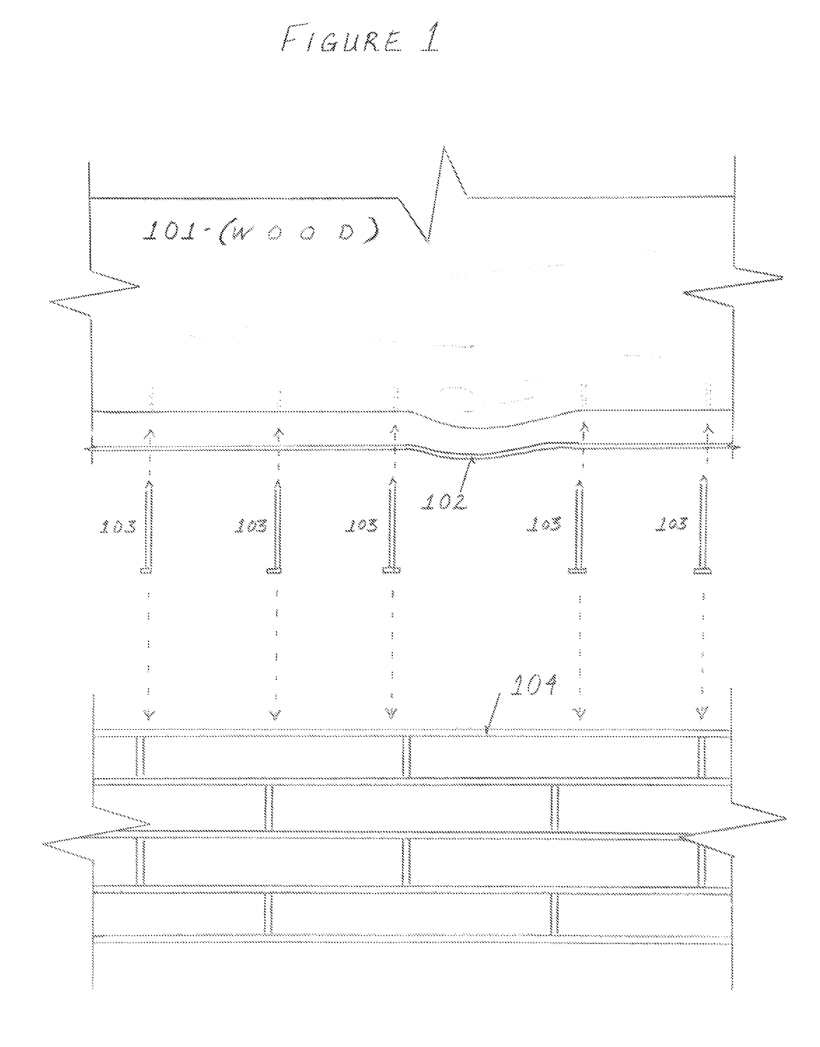

FIG. 1 shows a method for creating a frame member for joining a wood product 101 and concrete 106.

Referring to FIG. 1, lag bolts 103 having a minimum length of six inches are screwed into an edge of treated and cured wood product 101. The lag bolts 103 may have a variety of different diameters (but should be no smaller than ¼ inches in diameter and may generally be ⅜ inches in diameter so long as there is sufficient room between lag bolts and eventual concrete surface to avoid ‘ghosting’ or subtle shadowing or differing of appearance at surface of finished concrete). The lag bolts 103 screwed into an edge of the wood product 101, wherein a minimum of two inches of the lag bolts 103 is left exposed from the wood. However, the lag bolts 103 may protrude from the wood product 101 so that a range from two to four inches of the lag bolts 103 may be left exposed from the wood in order to maintain a straight or flush line for which our steel rebar frame 104 will be welded to. The exposed ends of the lag bolts 103 are then adjusted with minor loosening out of wood or tightening into wood as needed in order to achieve a straight line with all lag bolt heads, so they may line up flush with our prepared steel rebar frame 104. Lag bolts 103 are then grinded to prepare said lag bolts 103 to be welded to a steel rebar frame 104, guarding against molten metal splatter while welding (as needed). The steel rebar frame 104 is then welded to the exposed ends of the lag bolts 103 that have been grinded. The combination of the treated and cured wood product 101, the lag bolts 103, and the steel rebar frame 104 is then framed in a melamine, rubber or wood form (not shown) in order to prepare the product for pouring of concrete.

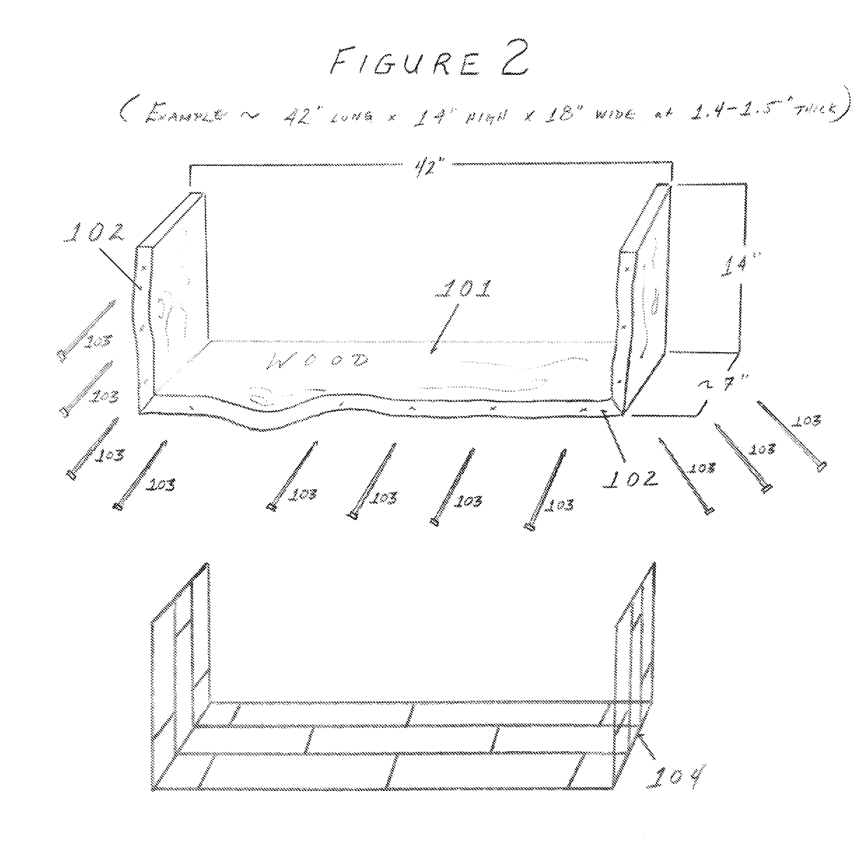

FIG. 2 shows a process of placing lags bolts 103 in a treated and cured wood portion 101 of a piece of furniture in order to prepare for a concrete pour.

Referring to FIG. 2, lag bolts 103 are screwed into an edge of a treated and cured wood product 101. The lag bolts 103 are preferably spaced apart by a distance between eight and ten inches apart in areas where the wood product 101 has a generally straight edge and is free from natural knots or irregularities. However, the lag bolts 103 are mounted closer together in areas where the wood product 101 has an irregular shape in order to gain strength and/or rigidity in hybrid wood/concrete combination piece; especially wherein the lag bolts 103 may be placed further apart next to this tighter spacing of lag bolts 103 where there exists a natural knot or potentially unstable area within the wood product 101. This series of lag bolt heads that are exposed from the wood product 101 are then aligned parallel to one another to allow a connection point on the head of each lag bolt 103 to the prepped rebar frame 104 that it is to be welded to.

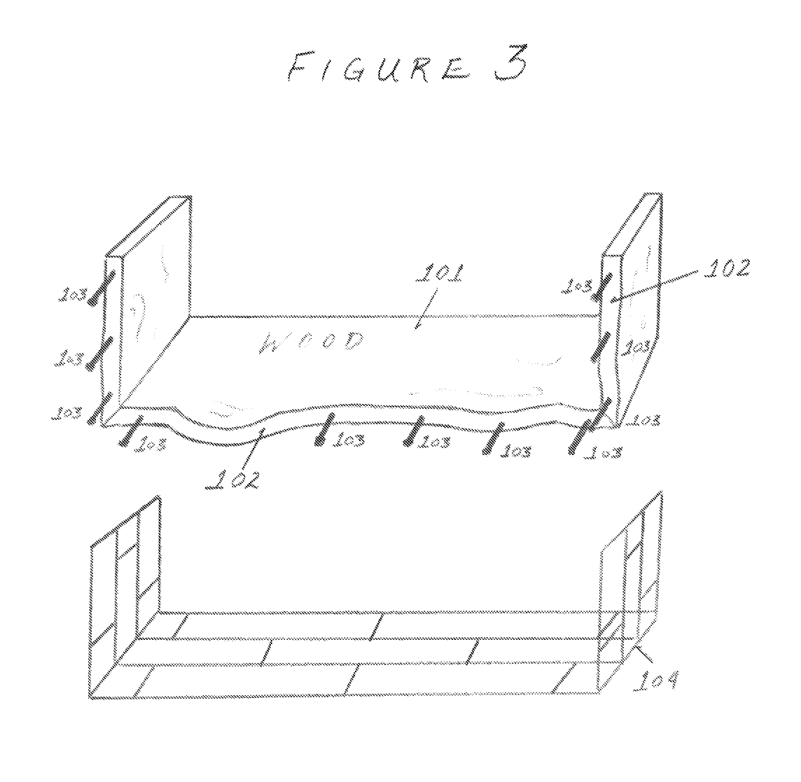

FIG. 3 shows a process of attaching a steel rebar frame 104 to lag bolts 103 placed in a wood portion 101 of a piece of furniture in order to prepare for a concrete pour. Each lag bolt 103 can be tightened into the wood product 101 or loosened from the wood product 101 slightly as needed in order to align all lag bolt 103 heads so that each lag bolt 103 head forms a tight line enabling all lag bolts 103 to be cleanly welded to the prepared rebar frame 104.

Referring to FIG. 3, lag bolts 103 are screwed into an edge of a wood product 101, wherein between two and three inches of the lag bolts 103 are left exposed from the wood product 101. The exposed sections of the lag bolts 103 are then adjusted with minor loosening or tightening as needed in order to line up with our prepared steel rebar frame 104. Lag bolts 103 are then grinded in order to prepare the surface of the lag bolts 103 to be welded to a steel rebar frame 104 to guard against weld splatter. The steel rebar frame 104 is then welded to the exposed section of the lag bolts 103 so that the wood product 101, the lag bolts 103 and the steel rebar frame 104 are fixed together as a single unit.

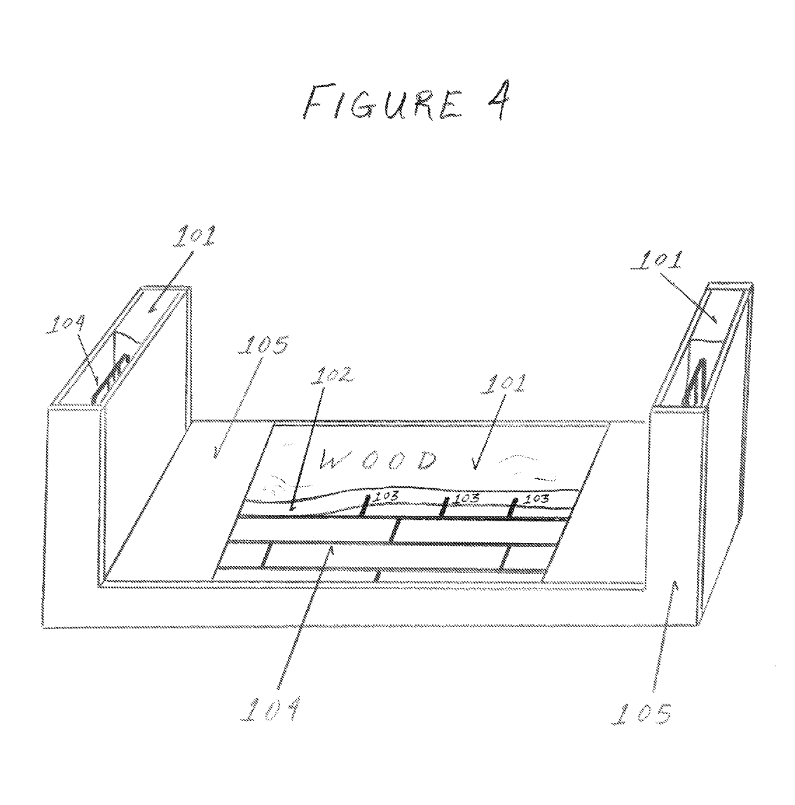

FIG. 4 shows a process of framing a treated and cured wood portion 101 of a piece of furniture, lag bolts 103 and rebar frame 104 in a melamine, rubber or wood form 105 in order to prepare the wood portion 101, lag bolts 103 and rebar frame 104 so that concrete 106 can be poured into the frame and cured.

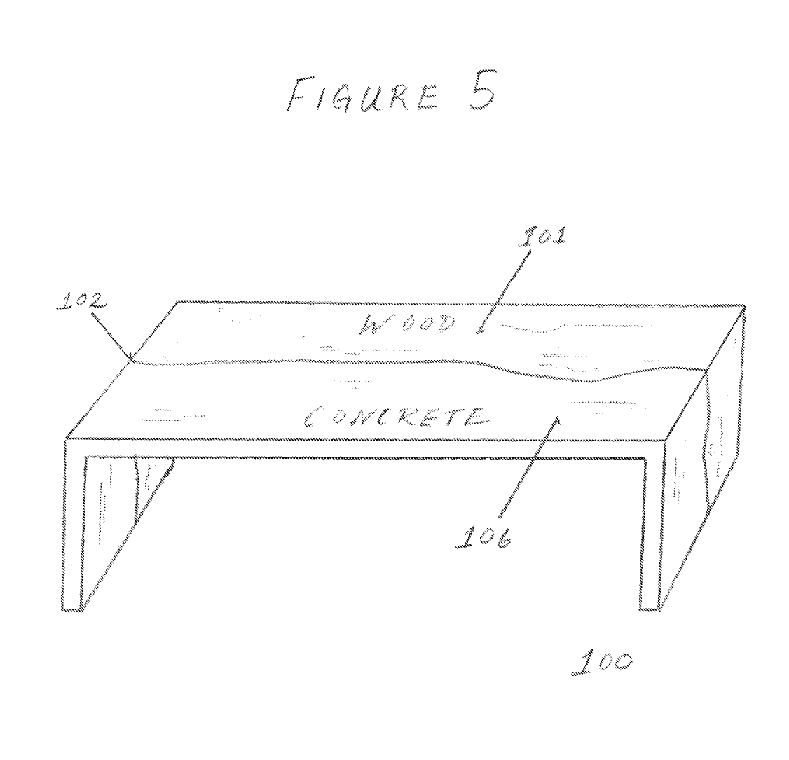

Referring to FIG. 4, a form 105 made of melamine, rubber or wood is constructed around the unit comprising the wood portion 101, the lag bolts 103, and the rebar frame 104. Concrete 106 is then poured into the form 105 so that the concrete 106 completely covers the exposed portions of the lag bolts 103 and the entire rebar frame 104. The concrete is then allowed to cure for a desired amount of time. When the concrete is fully cured for a desired amount of time the form 105 is removed to expose a hybrid wood/concrete furniture product 100 as shown in FIG. 5. The finished hybrid wood/concrete furniture product 100 has a virtually seamless joint 102 that does not include any large bumps or irregularities. In addition, the concrete 106 has minimal cracking due to the strategically placed lag bolts 103 and the rebar frame 104. The hybrid wood/concrete furniture product 100 includes a wood portion 101 that has a natural and irregular surface that seamlessly joins the concrete 106 and provides a generally flat finished surface.

What is claimed is:

1. A method for adjoining wood and concrete to form hybrid wood and concrete furniture, the method comprising: screwing a plurality of lag bolts into an edge of a wood product; grinding the exposed ends of the lag bolts; fixing the grinded and exposed ends of the lag bolts to a steel rebar frame, framing a melamine, rubber or wood form around the combination of the wood product, the lag bolts and the steel rebar frame; and pouring concrete into the melamine, rubber or wood form in order to encase the lag bolts and steel rebar frame in concrete.

2. The method of claim 1, wherein the lag bolts are screwed into the wood product so that a minimum of two inches of each of the lag bolts protrudes from the wood.

3. The method of claim 1, wherein the lag bolts are spaced apart by a distance between eight and ten inches apart in areas where the wood product has a generally straight edge and is free from natural knots or irregularities.

4. The method of claim 1, wherein the lag bolts are spaced apart by a distance of less than eight inches in areas where the wood product has an irregular or non-straight edge.

5. The method of claim 1, wherein no lag bolts are screwed into an edge of the wood product in an area within ten inches of a natural knot or irregularity in the wood product.

6. A frame member for joining wood and concrete, the frame member comprising: a wood product, a plurality of lag bolts, a steel rebar frame, and a melamine, rubber or wood frame.

7. The frame member of claim 6, wherein the lag bolts are screwed into the wood product so that a minimum of two inches of each of the lag bolts protrudes from the wood.

8. The frame member of claim 6, wherein the lag bolts are spaced apart by a distance between eight and ten inches apart in areas where the wood product has a generally straight edge and is free from natural knots or irregularities.

9. The frame member of claim 6, wherein the lag bolts are spaced apart by a distance of less than eight inches in areas where the wood product has an irregular or non-straight edge.

10. The frame member of claim 6, wherein no lag bolts are screwed into an edge of the wood product in an area within ten inches of a natural knot or irregularity in the wood product.
